(19) United States
(12) Patent Application Publication
(10) Pub. No.: US 2025/0192907 A1
(43) Pub. Date: Jun. 12, 2025

(54) RADIO APPARATUS FOR VEHICLE AND CONTROL METHOD THEREOF

(71) Applicants: Hyundai Motor Company, Seoul (KR); Kia Corporation, Seoul (KR)

(72) Inventor: Oh Yun KWON, Hwaseong-si (KR)

(73) Assignees: Hyundai Motor Company, Seoul (KR); Kia Corporation, Seoul (KR)

(21) Appl. No.: 18/956,459

(22) Filed: Nov. 22, 2024

(30) Foreign Application Priority Data
Dec. 8, 2023 (KR) 10-2023-0177338

(51) Int. Cl. H04H 40/18; H04H 20/12; H04H 20/53

(52) U.S. Cl. CPC H04H 40/18; H04H 20/12; H04H 20/53

(57) ABSTRACT

A method for controlling a radio apparatus for a vehicle, includes: determining of scanning determining whether to scan alternative broadcasts based on a signal quality of a listening broadcast; scanning the alternative broadcasts; determining of noise determining noise types of the alternative broadcasts based on a plurality of polarizations; comparing and determining comparing signal qualities of the listening broadcast and the alternative broadcasts based on a determination result of the determining of noise and determining whether to switch the listening broadcast to one of the alternative broadcasts; and switching the listening broadcast to the alternative broadcast based on a determination result of the comparing and determining.

### CROSS-REFERENCE TO RELATED APPLICATION

The present application claims priority to Korean Patent Application No. 10-2023-0177338, filed on Dec. 8, 2023, the present disclosure of which is incorporated herein by reference in its entirety.

### BACKGROUND OF THE PRESENT DISCLOSURE

### Field of the Present Disclosure

The present disclosure relates to a radio apparatus for a vehicle and a control method thereof.

### Description of Related Art

The content described below simply provides background information related to the present disclosure and does not form the related art.

Vehicles are provided with radios and Digital Multimedia Broadcasting (DMB) apparatus, and vehicle passengers may use the apparatus to listen to radio (AM/FM) or DMB radio broadcasts. While a vehicle is driving, if the vehicle moves away from a transmitter of a currently tuned broadcast (in what follows, referred to as the ‘listening broadcast’), the received signal strength weakens, and the listening conditions deteriorate; therefore, it is essential to improve the broadcast listening conditions by switching to a different frequency of the same broadcast.

In this regard, the broadcast listening conditions may be improved by scanning the same broadcast as the listening broadcast using an additional tuner in addition to a main tuner and switching the frequency according to the signal quality of the listening broadcast.

Meanwhile, various types of communication noise are introduced into the vehicle. Noise flowing into the vehicle may be classified into external noise caused by various environmental factors outside the vehicle and internal noise arising from the configurations of radiating antennae and cables within the vehicle. Noise flowing into vehicles may affect radio communication and deteriorate broadcast listening conditions.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method for controlling a radio apparatus for a vehicle, the method including: determining of scanning determining whether to scan alternative broadcasts based on a signal quality of a listening broadcast; scanning the alternative broadcasts; determining of noise determining noise types of the alternative broadcasts based on a plurality of polarizations; comparing and determining comparing signal qualities of the listening broadcast and the alternative broadcasts based on a determination result of the determining of noise and determining whether to switch the listening broadcast to one of the alternative broadcasts; and switching the listening broadcast to the alternative broadcast based on a determination result of the comparing and determining.

According to various aspects of the present disclosure, the present disclosure provides a radio apparatus for a vehicle, the apparatus including: a polarization switcher configured for generating a plurality of polarizations; a signal processor configured to process signal related to a listening broadcast and signals related to alternative broadcasts based on the plurality of polarizations; and a processor operatively connected to the polarization switcher and the signal processor and configured to switch the listening broadcast to an alternative broadcast, which is one of the alternative broadcasts, based on information transmitted from the signal processor, wherein the processor is configured to determine the noise type of the alternative broadcast based on information transmitted from the signal processor, compares signal qualities of the listening broadcast and the alternative broadcast based on the noise type, and switches the listening broadcast to the alternative broadcast.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### BRIEF DESCRIPTION OF THE DRAWINGS

FIG. 1 is a block diagram of a radio apparatus for a vehicle according to an exemplary embodiment of the present disclosure.

FIG. 2 is a block diagram of a signal processor according to an exemplary embodiment of the present disclosure.

FIG. 3 is a table showing an example of information related to a listening broadcast and alternative broadcasts according to an exemplary embodiment of the present disclosure.

FIGS. 4A and 4B illustrate a principle for determining the noise type of an alternative broadcast according to an exemplary embodiment of the present disclosure.

FIG. 5 is a flow diagram of a method for controlling a radio apparatus for a vehicle according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The radio apparatus for a vehicle according to an exemplary embodiment of the present disclosure is configured to switch frequencies and/or polarizations based on the noise type of alternative broadcasts, improving the radio signal quality within the vehicle and providing high-quality services to passengers.

Technical objects to be achieved by the present disclosure are not limited to those described above, and other technical objects not mentioned above may also be clearly understood from the descriptions provided below by those skilled in the art to which the present disclosure belongs.

Hereinafter, some exemplary embodiments of the present disclosure will be described in detail with reference to the accompanying drawings. In the following description, like reference numerals preferably designate like elements, although the elements are shown in different drawings. Furthermore, in the following description of various exemplary embodiments of the present disclosure, a detailed description of known functions and configurations incorporated therein will be omitted for clarity and for brevity.

Additionally, various terms such as first, second, A, B, (a), (b), etc., are used solely to differentiate one component from the other but not to imply or suggest the substances, order, or sequence of the components. Throughout the present specification, when a part ‘includes’ or ‘comprises’ a component, the part is meant to further include other components, not to exclude thereof unless stated to the contrary. The terms such as ‘unit’, ‘module’, and the like refer to one or more units for processing at least one function or operation, which may be implemented by hardware, software, or a combination thereof.

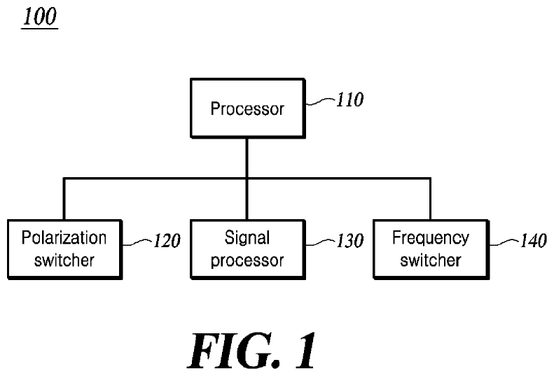

FIG. 1 is a block diagram of a radio apparatus for a vehicle according to an exemplary embodiment of the present disclosure.

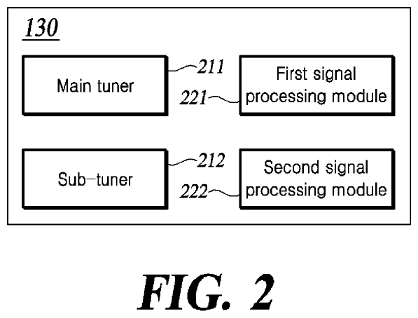

FIG. 2 is a block diagram of a signal processor according to an exemplary embodiment of the present disclosure.

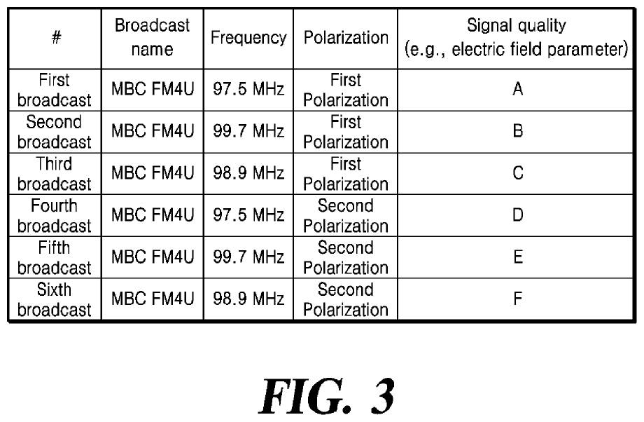

FIG. 3 is a table showing an example of information related to a listening broadcast and alternative broadcasts according to an exemplary embodiment of the present disclosure.

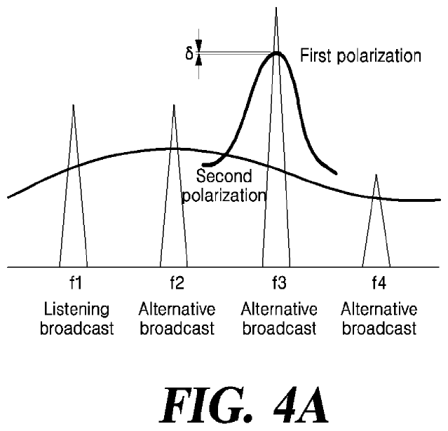

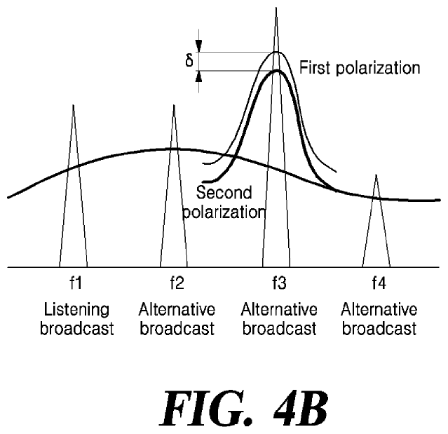

FIGS. 4A and 4B illustrate a principle for determining the noise type of an alternative broadcast according to an exemplary embodiment of the present disclosure.

Referring to FIG. 1 and FIG. 2, a radio apparatus for a vehicle 100 according to an exemplary embodiment of the present disclosure may include a processor 110, a polarization switcher 120, a signal processor 130, and a frequency switcher 130.

The signal processor 130 may include a main tuner 211, a sub-tuner 212, a first signal processing module 221, and a second signal processing module 222.

The processor 110 may receive information on a currently tuned broadcast (in what follows, referred to as a ‘listening broadcast’) and alternative broadcasts from the signal processor 130. Here, the alternative broadcast means a radio broadcast that includes the same content as the listening broadcast but is broadcast at a different frequency and/or polarization from the listening broadcast. For example, as shown in FIG. 3, when the listening broadcast is a first broadcast, alternative broadcasts refer to second to sixth broadcasts, providing the same content as the first broadcast, namely, the same broadcast program name, MBC FM4U, but being broadcast at different frequencies and/or polarizations from the first broadcast.

The processor 110 is configured to determine whether to scan the alternative broadcasts based on the signal (information) transmitted from the signal processor 130. The processor 110 is configured to determine whether to scan alternative broadcasts based on the signal quality of the listening broadcast. The processor 110 is configured to determine whether to scan the alternative broadcasts based on whether the signal strength of the listening broadcast is greater than or equal to a reference signal strength. When the signal strength of the listening broadcast is greater than the reference signal strength, the processor 110 may be configured for controlling the signal processor 130 not to scan for alternative broadcasts because the signal quality of the listening broadcast is sufficiently good. If the signal strength of the listening broadcast is less than the reference signal strength, the processor 110 may be configured for controlling the signal processor 130 to scan alternative broadcasts to find a broadcast with better signal quality.

The signal processor 130 may be configured to receive and process signals related to a listening broadcast and alternative broadcasts. The main tuner 211 and the first signal processing module 221 of the signal processor 130 may be configured to receive and process signals related to the listening broadcast, and the sub-tuner 212 and the second signal processing module 222 may be configured to receive and process signals related to alternative broadcasts.

The signal processor 130 may scan alternative broadcasts. When the processor 110 determines that the signal strength of the listening broadcast is lower than a reference signal strength, the signal processor 130 may scan for alternative broadcasts. The signal processor 130 may select alternative broadcasts using the sub-tuner 212 and the second signal processing module 222 and collect information on the selected alternative broadcasts.

The signal processor 130 may select alternative broadcasts based on the signal patterns of a plurality of detected broadcasts and the listening broadcast. The signal processor 130 may select broadcasts exhibiting the Dual Tuner Acoustic Correlation (DTAC) with the listening broadcast above a threshold among the plurality of detected broadcasts as alternative broadcasts. As described above, here, the alternative broadcast refers to a radio broadcast that has the same content as the listening broadcast, has the same broadcast name, but is broadcast at a different frequency and/or polarization. The signal processor is configured to determine the DTAC between a plurality of detected broadcasts and the listening broadcast based on the information on the radio broadcast stored in a memory and/or a server and signals received through the sub-tuner 212.

Meanwhile, as described above, the signal processor 130 may select an alternative broadcast based on the received signal, but the processor 110 may also select an alternative broadcast based on the signal received by the signal processor 130.

The signal processor 130 may receive signals of selected alternative broadcasts and collect information on the frequency, polarization, signal quality (e.g., signal strength), and/or noise. The signal processor 130 may be configured for processing the signal and transmit the collected information to the processor 110.

The polarization switcher 120 may be configured to generate and use a plurality of polarizations. The polarization switcher 120 may be configured to generate a first polarization and a second polarization. The difference in polarization angle between the first and second polarizations may be 90 degrees. The signal processor 130 may be configured for processing signals related to alternative broadcasts based on a plurality of polarizations generated by the polarization switcher 120.

The processor 110 may be configured to determine the type of noise of an alternative broadcast based on a plurality of polarizations. The processor 110 may be configured to determine the type of noise of an alternative broadcast based on changes in the noise according to a plurality of polarizations. For example, as shown in FIG. 4A, when the noise variation & according to each of the first polarization and the second polarization is below a reference value, the processor 110 is configured to determine that the noise type of the alternative broadcast is external noise; when the noise variation & exceeds the reference value as shown in FIG. 4B, the processor 110 is configured to determine that the noise type is internal noise. Here, external noise refers to noise generated by various environmental factors outside the vehicle, and internal noise refers to noise arising from the configurations of radiating antennae and cables within the vehicle. Accordingly, due to the characteristics of external noise and internal noise, external noise does not continue to flow into the vehicle, but the polarization of the external noise continues to change randomly depending on the surrounding environment, while internal noise continues to flow into the vehicle, but the polarization of the internal noise is constant regardless of the surrounding environment. The radio apparatus for a vehicle 100 according to an exemplary embodiment of the present disclosure may more effectively improve the radio signal quality by determining the noise type based on a plurality of polarizations and determining whether to switch the frequency and/or polarizations based on the determined noise type.

The polarization switcher 120 may be configured to generate and use a plurality of polarizations. The polarization switcher 120 may be configured to generate a first polarization and a second polarization. The difference in polarization angle between the first and second polarizations may be 90 degrees. The signal processor 130 may be configured for processing signals related to alternative broadcasts based on a plurality of polarizations generated by the polarization switcher 120.

The processor 110 may compare the signal quality of the listening broadcast and the signal qualities of alternative broadcasts to determine whether to switch the listening broadcast to one of the alternative broadcasts; if the signal quality of an alternative broadcast is superior to the signal quality of the listening broadcast, the processor 110 may switch the frequency and/or polarization to the values corresponding to the alternative broadcast using the polarization switcher 120 and/or the frequency switcher 140 and switch the listening broadcast to the alternative broadcast.

Referring again to FIG. 3, assuming that the first broadcast corresponds to a listening broadcast and the second to sixth broadcasts are alternative broadcasts, the processor 110 may compare the signal quality of the first broadcast, which is the listening broadcast, with the signal qualities of the second to sixth broadcasts, which are the alternative broadcasts, based on the information transmitted from the signal processor 130. At the instant time, the signal quality may be signal strength or electric field parameters according to electric field conditions, where FIG. 3 shows an example of the electric field parameters. If the electric field parameter A is superior to B, C, D, E, and F, the processor 110 may be configured to determine that the signal quality of the listening broadcast is superior to those of the alternative broadcasts and determine not to switch the frequency and polarization. Conversely, if the electric field parameter B is better than A, the second broadcast corresponds to an alternative broadcast, and the processor 110 is configured to determine that it is necessary to switch the first broadcast, which is the listening broadcast, to the second broadcast, which is the alternative broadcast. Here, because the second broadcast includes the same polarization as the first broadcast and only the frequency thereof is different from that of the first broadcast, the processor 110 may change the first broadcast to the second broadcast by switching the frequency using the frequency switcher 140. In another example, when the electric field parameter D is better than A, the fourth broadcast corresponds to an alternative broadcast, and the processor 110 is configured to determine that it is necessary to switch the first broadcast, which is the listening broadcast, to the fourth broadcast, which is the alternative broadcast. Here, because the fourth broadcast includes the same frequency as the first broadcast but only the polarization thereof is different from that of the first broadcast, the processor 110 may change the first broadcast to the fourth broadcast by switching the polarization using the polarization switcher 120. In yet another example, when the electric field parameter E is better than A, the fifth broadcast corresponds to an alternative broadcast, and the processor 110 is configured to determine that it is necessary to switch the first broadcast, which is the listening broadcast, to the fifth broadcast, which is the alternative broadcast. Here, because the fifth broadcast is different from the first broadcast in both frequency and polarization, the processor 110 may switch the first broadcast to the fifth broadcast by switching the frequency and polarization using the frequency switcher 140 and the polarization switcher 120.

As described above, the radio apparatus for a vehicle 100 according to an exemplary embodiment of the present disclosure may be configured to switch to an alternative broadcast exhibiting a better signal quality than the listening broadcast when the signal quality of the listening broadcast deteriorates and provide high-quality services to vehicle passengers by improving the signal quality through scanning of alternative broadcasts of which the frequency and polarization are different from those of the listening broadcast.

In addition to the above, the processor 110 according to an exemplary embodiment of the present disclosure may compare the signal qualities of the listening broadcast and the alternative broadcast based on the noise type of the alternative broadcast to determine whether to switch the listening broadcast to the alternative broadcast. When the noise type of the alternative broadcast is external noise, the processor 110 compares the signal qualities of the listening broadcast and the alternative broadcasts multiple times and is configured to determine whether the number of cases where the signal quality of the alternative broadcast is superior to signal quality of the listening broadcast is greater than or equal to a predetermined number. If the number of cases where the signal quality of an alternative broadcast, which is one of the alternative broadcasts, is superior to signal quality of the listening broadcast is greater than or equal to the predetermined number, the processor 110 is configured to determine to switch the listening broadcast to the alternative broadcast and switches the frequency and/or polarization to the values corresponding to the alternative broadcast. When the noise type of the alternative broadcast is internal noise, the processor 110 compares the signal qualities of the listening broadcast and the alternative broadcasts; if the signal quality of the alternative broadcast is superior to signal quality of the listening broadcast, the processor 110 switches the frequency and/or polarization to the values corresponding to the alternative broadcast. As described above, the radio apparatus for a vehicle 100 according to an exemplary embodiment of the present disclosure may classify the noise type of an alternative broadcast into external noise and internal noise and is configured to determine whether to switch the frequency and/or polarization based on the characteristics of each noise type, more effectively improving the signal quality.

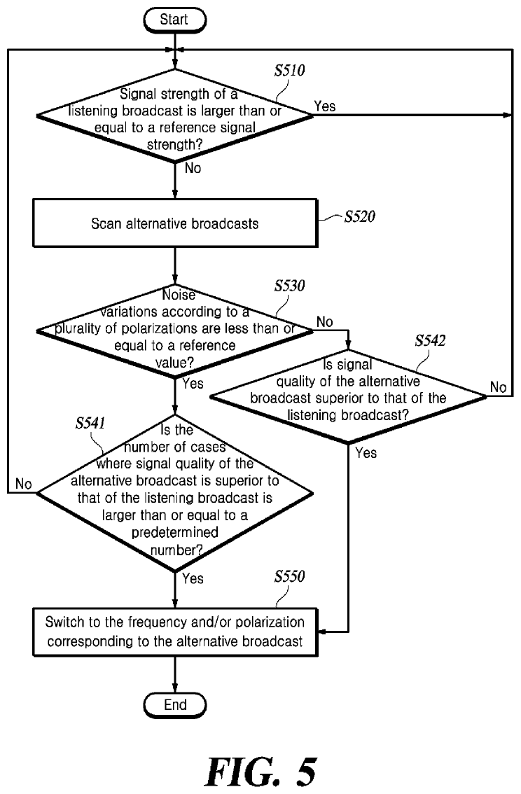

FIG. 5 is a flow diagram of a method for controlling a radio apparatus for a vehicle according to an exemplary embodiment of the present disclosure.

The processor 110 is configured to determine whether to scan alternative broadcasts based on the signal quality of the listening broadcast. The processor 110 is configured to determine whether to scan the alternative broadcasts based on whether the signal strength of the listening broadcast is greater than or equal to the reference signal strength S510.

If the signal strength of the listening broadcast is weaker than the reference signal strength, the signal processor 130 scans the alternative broadcasts S520. The signal processor 130 selects alternative broadcasts. The signal processor 130 selects alternative broadcasts based on the signal patterns of a plurality of detected broadcasts and the listening broadcast. The signal processor 130 may select a broadcast exhibiting a value of the DTAC greater than a threshold among the plurality of detected broadcasts as an alternative broadcast. The signal processor 130 collects information on the alternative broadcast. The signal processor 130 may receive signals of the selected alternative broadcasts and collect information on the frequency, polarization, and/or signal quality.

The processor 110 is configured to determine the type of noise of an alternative broadcast based on a plurality of polarizations. The processor 110 is configured to determine the type of noise of an alternative broadcast based on changes in the noise according to a plurality of polarizations. The processor 110 is configured to determine whether the noise variation according to the plurality of polarizations is less than or equal to the reference value S530. The processor 110 may be configured to determine that the noise type to be an external noise if the noise variation is less than or equal to the reference value and may be configured to determine that the noise type is internal noise if the noise variation exceeds the reference value.

If it is determined that the noise type of the alternative broadcast is external noise, the processor 110 compares the signal qualities of the listening broadcast and the alternative broadcasts multiple times and is configured to determine whether the number of cases where the signal quality of an alternative broadcast among the alternative broadcasts is superior to signal quality of the listening broadcast is greater than or equal to a predetermined number S541. If the number of cases where the signal quality of an alternative broadcast among the alternative broadcasts is superior to signal quality of the listening broadcast is greater than or equal to the predetermined number, the processor 110 is configured to determine that the listening broadcast needs to be switched to the alternative broadcast.

If it is determined that the noise type the alternative broadcast is internal noise, the processor 110 compares the signal qualities of the listening broadcast and the alternative broadcasts and is configured to determine whether the signal quality of one of the alternative broadcasts is superior to signal quality of the listening broadcast S542. If the signal quality of the alternative broadcast is better than that of the listening broadcast, the processor 110 is configured to determine that the listening broadcast needs to be switched to the alternative broadcast.

The processor 110 switches the frequency and/or polarization to the values corresponding to the alternative broadcast using the polarization switcher 120 and/or the frequency switcher 140 S550. If the noise type of the alternative broadcast is external noise, and the number of cases where the signal quality of the alternative broadcast is superior to signal quality of the listening broadcast is greater than or equal to a predetermined number, the processor 110 switches the frequency and/or polarization to the values corresponding to the alternative broadcast. If the noise type of the alternative broadcast is internal noise, and the number of cases where the signal quality of the alternative broadcast is superior to signal quality of the listening broadcast is greater than or equal to a predetermined number, the processor 110 switches the frequency and/or polarization to the values corresponding to the alternative broadcast.

According to an exemplary embodiment of the present disclosure, a radio apparatus for a vehicle is configured to switch frequencies and/or polarizations based on the noise type of alternative broadcasts, improving the radio signal quality within the vehicle and providing high-quality services to passengers.

Although it is described that the processes are sequentially executed in the flowchart of the present disclosure, this is merely illustrative of the technical idea of various exemplary embodiments of the present disclosure. In other words, because an ordinary skilled person in the art to which the exemplary embodiments of the present disclosure pertain may make various modifications and changes by changing the processes described in the flowchart/timing diagram or performing one or more of the processes in parallel without departing from the essential characteristics of the exemplary embodiments of the present disclosure, the flowchart/timing diagram is not limited to a time-series order.

Various implementations of the systems and techniques described herein may be realized by digital electronic circuits, integrated circuits, field programmable gate arrays (FPGAs), application specific integrated circuits (ASICs), computer hardware, firmware, software, and/or combination thereof. These various implementations may include an implementation by one or more computer programs executable on a programmable system. The programmable system includes at least one programmable processor (which may be a special purpose processor or a general-purpose processor) coupled to a storage system, at least one input device, and at least one output device to receive and transmit data and instructions therefrom and thereto. Computer programs (also known as programs, software, software applications or codes) include instructions for the programmable processor and are stored in a “computer-readable recording medium”.

The computer-readable recording medium includes all types of recording devices in which data readable by a computer system is stored. The computer-readable recording medium may include non-volatile or non-transitory mediums such as ROM, RAM, CD-ROM, magnetic tape, floppy disk, memory card, hard disk, optical disk, and storage device, and may further include a temporary medium such as a data transmission medium. In addition, the computer-readable recording medium may be distributed in a network-connected computer system, and computer-readable codes may be stored and executed in a distributed manner.

Various implementations of systems and techniques described herein may be implemented by a programmable computer. Here, the computer includes a programmable processor, a data storage system (including a volatile memory, a nonvolatile memory, or another type of storage system or a combination thereof), and at least one communication interface. For example, a programmable computer may be one of a server, a network device, a set-top box, a built-in device, a computer expansion module, a personal computer, a laptop, a personal data assistant (PDA), a cloud computing system, and a mobile device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for controlling a radio apparatus for a vehicle, the method comprising:
determining of scanning including determining whether to scan alternative broadcasts based on a signal quality of a listening broadcast;
scanning the alternative broadcasts;
determining of noise including determining noise types of the alternative broadcasts based on a plurality of polarizations;
comparing and determining including comparing signal qualities of the listening broadcast and the alternative broadcasts based on a determination result of the determining of noise and determining whether to switch the listening broadcast to an alternative broadcast, which is one of the alternative broadcasts; and
switching the listening broadcast to the alternative broadcast based on a determination result of the comparing and determining.

2. The method of claim 1, wherein the determining of noise further includes determining the noise type of the alternative broadcast based on noise variations according to the plurality of polarizations.

3. The method of claim 2, wherein the determining of noise further includes:
determining the noise type to be an external noise in response that the noise variations are less than or equal to a reference value; and
determining the noise type to be an internal noise in response that the noise variations exceed the reference value.

4. The method of claim 3, wherein, in response that the noise type of the alternative broadcast is determined to be the external noise in the determining of noise, the comparing and determining further includes comparing signal qualities of the listening broadcast and the alternative broadcast multiple times and based on whether a number of cases where the signal quality of the alternative broadcast, which is one of the alternative broadcasts, is superior to the signal quality of the listening broadcast is greater than or equal to a predetermined number, and determining whether to switch the listening broadcast to the alternative broadcast; and
in response that the noise type of the alternative broadcast is determined to be the internal noise in the determining of noise, the comparing and determining further includes determining whether to switch the listening broadcast to the alternative broadcast based on whether the signal quality of the alternative broadcast, which is one of the alternative broadcasts, is superior to the signal quality of the listening broadcast.

5. The method of claim 4, wherein, in response that the noise type of the alternative broadcast is determined to be the external noise in the determining of noise, the switching includes switching the listening broadcast to the alternative broadcast in response that the number of cases where the signal quality of the alternative broadcast is superior to the signal quality of the listening broadcast is greater than or equal to a predetermined number; and
in response that the noise type of the alternative broadcast is determined to be the internal noise in the determining of noise, the switching includes switching the listening broadcast to the alternative broadcast in response that the signal quality of the alternative broadcast is superior to the signal quality of the listening broadcast.

6. The method of claim 1, wherein the alternative broadcast provides a same content as the listening broadcast, and at least one of the frequency and the polarization thereof is different from that of the listening broadcast.

7. A radio apparatus for a vehicle, the apparatus comprising:
a polarization switcher configured for generating a plurality of polarizations;
a signal processor configured to process signal related to a listening broadcast and signals related to alternative broadcasts based on the plurality of polarizations; and
a processor operatively connected to the polarization switcher and the signal processor and configured to switch the listening broadcast to an alternative broadcast, which is one of the alternative broadcasts, based on information transmitted from the signal processor,
wherein the processor is further configured to determine a noise type of the alternative broadcast based on the information transmitted from the signal processor, to compare signal qualities of the listening broadcast and the alternative broadcast based on the noise type, and to switch the listening broadcast to the alternative broadcast.

8. The apparatus of claim 7, wherein the processor is further configured to determine the noise type based on noise variations according to the plurality of polarizations.

9. The apparatus of claim 7, wherein the polarization switcher includes a plurality of polarization antennae.

10. The apparatus of claim 7, wherein the polarization antenna includes one antenna and is made of PIN diodes.

11. The apparatus of claim 8, wherein in the determining of the noise type, the processor is further configured for:
determining the noise type to be an external noise in response that the noise variations are less than or equal to a reference value; and
determining the noise type to be an internal noise in response that the noise variations exceed the reference value.

12. The apparatus of claim 11, wherein, in response that the noise type of the alternative broadcast is determined to be the external noise in the determining of the noise type, the processor is further configured for comparing the signal qualities of the listening broadcast and the alternative broadcast multiple times and based on whether a number of cases where the signal quality of the alternative broadcast, which is one of the alternative broadcasts, is superior to the signal quality of the listening broadcast is greater than or equal to a predetermined number, and for determining whether to switch the listening broadcast to the alternative broadcast; and
in response that the noise type of the alternative broadcast is determined to be the internal noise in the determining of the noise type, the processor is further configured for determining whether to switch the listening broadcast to the alternative broadcast based on whether the signal quality of the alternative broadcast, which is one of the alternative broadcasts, is superior to the signal quality of the listening broadcast.

13. The apparatus of claim 12, wherein, in response that the noise type of the alternative broadcast is determined to be the external noise in the determining of the noise type, the processor is further configured for switching the listening broadcast to the alternative broadcast in response that the number of cases where the signal quality of the alternative broadcast is superior to the signal quality of the listening broadcast is greater than or equal to the predetermined number; and
in response that the noise type of the alternative broadcast is determined to be the internal noise in the determining of the noise type, the processor is further configured for switching the listening broadcast to the alternative broadcast in response that the signal quality of the alternative broadcast is superior to the signal quality of the listening broadcast.

14. The apparatus of claim 7, wherein the alternative broadcast provides a same content as the listening broadcast, and at least one of frequency and polarization thereof is different from that of the listening broadcast.
